(19) United States
(12) Patent Application Publication
(10) Pub. No.: US 2006/0277584 A1
(43) Pub. Date: Dec. 7, 2006

(54) Data distribution, analysis and methods using integrated entertainment appliances

(76) Inventor: Norman L. Taylor, Old Hickory, TN (US)

Correspondence Address: Kenneth W. Float, 2095 Hwy. 211 NW, #2F, Braselton, GA, 30517, US

(21) Appl. No.: 11/146,843

(22) Filed: Jun. 7, 2005

(51) Int. Cl. H04N 7/18; H04N 7/173

(52) U.S. Cl. 725/112; 725/113; 725/78; 725/80; 725/81

(57) ABSTRACT

Systems and methods are disclosed that distribute data over the Internet and analyze data derived from entertainment appliances that integrate video, audio, telephone and email services in a residential or business environment. The architecture, components, and processing methods cooperate to provide integration, and deliver services at high speed.

### BACKGROUND

The present invention relates generally to distribution of data and communication signals to consumers, and related processing methods, and more particularly, to a data distribution and analysis system and methods employing integrated entertainment appliances.

There are a large number of systems and components that are currently sold that deliver various types of communication and entertainment services to consumers. Cable system operators distribute television and music programming via a set top box and cable modem. Satellite television operators distribute television and music programming via a set top satellite receiver. Satellite and Internet radio programs and music are distributed to consumers using standalone radio receivers, portable computers, and personal digital assistants (PDAs). Digital cell phones are available that permit audio and video communication between consumers. The Internet is widely used by consumers to download video and music files to their computers and purchase goods and services. Traditional telephone companies provide telephone services and digital subscriber line (DSL) services, and voice over Internet protocol (VOIP) telephone companies, such as Vonage, for example, are becoming popular.

However, no system is currently available that integrates all of these capabilities into a single unit for use by consumers while providing a secure environment. No system is currently available that allows downloading of copyrighted works while insuring that copyright laws are complied with. No system is currently available that provides these functions and substantially prevents hackers from tampering with the system. No system is currently available that permits distribution of high-definition-resolution quality video programming throughout a residence or business over a wireless Ethernet link. No system is currently available that permits high-definition-resolution quality videoconferencing over the Internet. It would be desirable to have a system whose architecture and components, along with processing methods implemented therein, are standards based, and cooperate to provide for such integration, and deliver services at high speed.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates an exemplary multimedia distribution and analysis system;

FIG. 2 illustrates details of an exemplary slave appliance;

FIG. 3 illustrates details of an exemplary vehicle appliance;

FIG. 4 illustrates details of an exemplary remote control;

FIG. 5 is a functional block diagram of the system;

FIG. 6 is an exemplary process flow diagram illustrating file downloading to a slave appliance; and

FIGS. And 8 are is a flow charts that illustrates exemplary methods using concepts disclosed herein.

### DETAILED DESCRIPTION

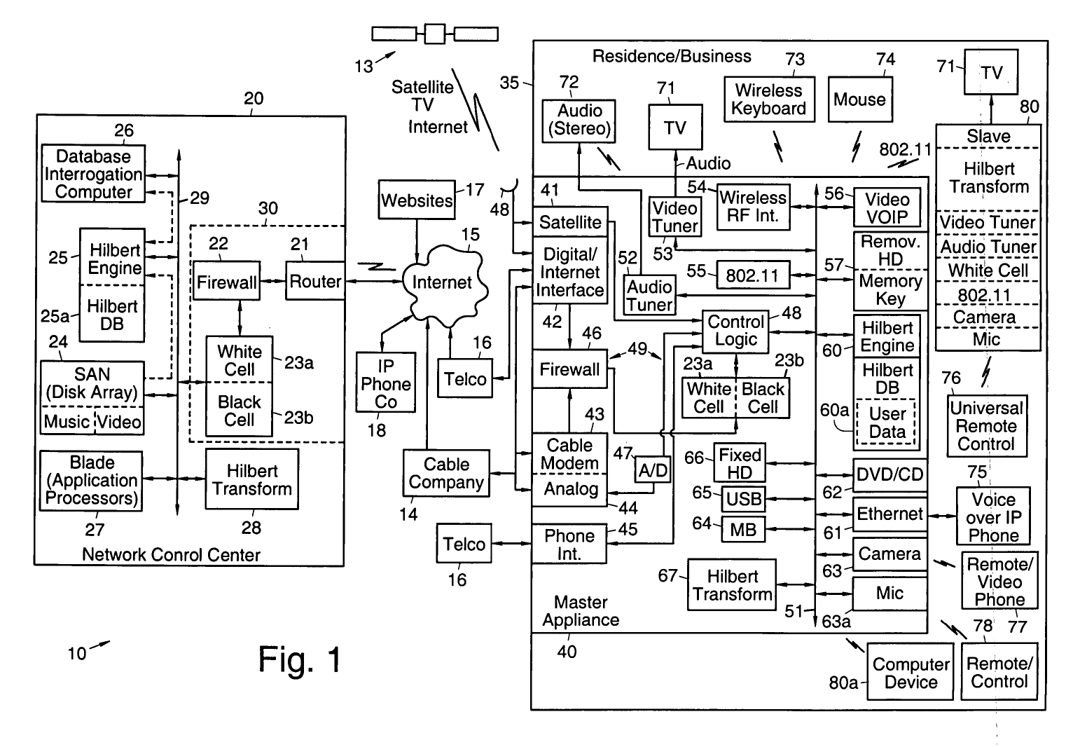

Referring to the drawing figures, FIG. 1 illustrates an exemplary multimedia distribution and analysis system 10. The multimedia distribution and analysis system 10 comprises a network control center 20 that communicates by way of a wide area network 15, such as the Internet 15, with master appliances 40 disposed in residences 35 and businesses 35. The network control center 20 facilitates downloading of files, such as music, data, and video files, for example, to the master appliances 40. The network control center 20 also monitors the master appliances 40 and provides facilities for troubleshooting and upgrading the master appliances 40 and analyzing data relating to use of the master appliances 40.

The network control center 20 comprises a firewall system 30 including a router 21, a firewall 22, and white cell and black cell control logic 23a, 23b. The firewall system 30 along with the white cell and black cell control logic 23a, 23b prevents unauthorized access to the network control center 20 and makes the network control center 20 “invisible” to individuals who are not authorized to communicate with the network control center 20. The firewall system 30 interfaces to a wide area network 15, such as the world wide web 15, Internet 15 or a business or home network coupled to the Internet 15.

Communication over the Internet 15 may be implemented using wired connections, wireless connections, or a combination of wired and wireless connections. A preferred connection to the Internet 15 is by way of a broadband link, such as OC12 for example, that provides for IP delivery over a point-to-point leased line connection having a bandwidth of up to about 622 Mbps.

The router 21 of the firewall system 30 is coupled to the Internet 15. The router 21 is coupled to the firewall 22 which is operative to prevent unauthorized access to the network control center 20. The firewall 22 is coupled to white cell and black cell control logic 23a, 23b. The white cell and black cell control logic 23a, 23b comprise software (firmware) that is operative to eliminate tampering or hacking of the network control center 20. The white cell and black cell control logic 23a, 23b are coupled to a local area network 29, such as an Ethernet or home wireless Ethernet network 31, for example.

A back-office management portion of the system 10 includes a data storage system 24, such as is provided by a wide storage area network (WSAN) 24, is coupled to the local area network 29. The wide storage area network 24 is a storage disk array, for example, that is used to store customer data, along with customer addressable IP (CAIP) data, relating to the master appliances 40 along with music and video files, for example. A first processor 25, referred to as a Hilbert database engine 25, which comprises a Hilbert database 25a, is coupled to the local area network 29. The Hilbert database engine 25 is a product that is available from Galaxy Technologies, LLC. A database interrogation computer 26 is coupled to the local area network 29. The Hilbert database engine 25 communicates with the wide storage area network 24 and the database interrogation computer 26 over the local area network 29. These communication paths are illustrated by the dashed, arrowed, lines interconnecting the devices.

A blade server network 27, comprising one or more application control logic 27, is coupled to the local area network 29. The blade server network 27 is operative to process data for storage in and retrieval from the wide storage area network 24.

A second processor 28, referred to as a Hilbert transform engine 28 (to distinguish it from the Hilbert database engine 25) is coupled to the local area network 29. The Hilbert transform engine 28 is a product that is available from Galaxy Technologies, LLC. The Hilbert transform engine 28 implements an algorithm that is operative to morph, convert, or transform, digital data into numerical data. For example, the Hilbert transform engine 28 may be configured to transform digital data into base-40 integers. Thus, each session of digital data that is to be transmitted from the network control center 20 is transformed (converted) into a unique (base-40) integer. During conversion, the original session of digital data retains its original context. The algorithm in the Hilbert transform engine 28 is also operative to transform, or morph, numerical data back to its original digital data form. Thus, in simplistic terms, the Hilbert transform engine 28 is operative to transform or convert a session of digital data into a unique number, and transform or convert the unique number back into the session of digital data. This same process occurs when data is transmitted from the master appliances 40 to the network control center 20.

While the illustrated network control center 20 is shown having both the Hilbert database engine 25 and a Hilbert transform engine 28, it is to be understood that the functionality of the two devices may be integrated into a single Hilbert engine.

The firewall 22 along with the white cell and black cell control logic 23a, 23b cooperate to secure the network control center 20 from attempts to attack the system 10 or tamper with devices in the network control center 20. The white cell control logic 23a encapsulates and reads encapsulated data transmitted between the network control center 20 and master appliances 40. The white cell control logic 23a encapsulates a data session with header and trailer records that defines authorized usage of the transmitted data. The encapsulated data is transmitted to a remote site (i.e., from the network control center 20 to the master appliance 40). A white cell control logic 23a in the master appliance 40 processes the encapsulated data in accordance with the authorization contained in the header and trailer records. Thus, only devices that are authorized to communicate with one another can read the transmitted data.

The master appliance 40 includes devices for receiving and transmitting data from and to multiple sources. A satellite receiver 41 coupled to an antenna 48 is provided for receiving television broadcasts from satellites 13, such as from DirecTV® of Dish Network® satellites 13, for example. A digital/Internet interface 42 having router functionality is provided for receiving digital and Internet traffic routed over the Internet 15 by way of the user's Internet Service Provider (ISP), such as a cable company 14 or a telephone company 16. Internet traffic may also be received by way of the satellites 13. A cable modem 43 is provided for receiving digital and Internet traffic routed over the Internet 15 by way of the user's ISP. A multi-channel analog receiver and tuner 44 is provided for receiving analog programming transmitted by way of the cable company 14. A telephone interface (RJ-11) 45 is provided for receiving telephone signals from the telephone company 16. The master appliance 40 may communicate by way of the Internet 15 with Internet websites 17 using the facilities of the ISP.

The digital/Internet interface 42 and cable modem 43 are coupled to a firewall system 49 (generally designated) comprising a firewall 46 plus white cell and black cell control logic 23a, 23b. The firewall 46 is coupled to the white cell and black cell control logic 23a, 23b. The firewall 46 along with the white cell and black cell control logic 23a, 23b cooperate to secure the master appliance 40 in the same manner as was described with regard to the network control center 20.

More particularly, the white cell control logic 23a in the master appliance 40 encapsulates and reads encapsulated data transmitted between the master appliance 40 and the network control center 20, and between the master appliance 40 and slave appliances 80 or other computer device 80a wirelessly coupled thereto.

For example, the white cell control logic 23a in the network control center 20 may be used to encapsulate a copyrighted audio or video file (i.e., add a header and trailer to the file) that is to be downloaded to the master appliance 40. The encapsulation defines authorized usage of the file, including the number of times the copyrighted file may be played or if the copyrighted file may be stored on the master appliance 40, for example. The white cell control logic 23a in the master appliance 40 reads the authorization usage contained in the encapsulation and the control logic 48 controls processing of the copyrighted file in accordance with what is authorized. This process insures that copyright laws are complied with.

The white cell control logic 23a is also operative to protect the software residing in devices in the master appliance 40. For example, if an unauthorized user attempts to open or hack into the master appliance 40, the white cell control logic 23a is programmed to detect the attempt and erase software and firmware in the master appliance 40, and transmit a signal (file) indicative of the tampering incident to the network control center 20.

Unauthorized persons cannot hack into the master appliance 40 because it is invisible to them due to the use of the black cell control logic 23b. The black cell control logic 23b is operative to prevent tampering, in that, in the event that a person attempts to query the master appliance 40, the black cell control logic 23b is operative to absorb any pings made thereto. If a ping is received from outside the master appliance 40, it is “absorbed” and stored in the black cell control logic 23b, and no ping is returned to the sender. In the event that an excessive number of pings are received from the same source, all stored pings relating to that source may be returned en masse, without including an IP address of the master appliance 40, which will act to disrupt the sender's computer.

Thus, the black cell control logic 23b monitors I/O ports of the master appliance 40 and reads IP addresses of senders of pings to the master appliance 40. If the sender is not authorized to communicate with the master appliance 40, the black cell control logic 23b generates an alarm signal, does not return the ping, and sends an event message to the network control center 20.

The white cell and black cell control logic 23a, 23b is coupled to control logic 48. The satellite receiver 41 is also coupled to the control logic 48. The multi-channel analog receiver and tuner 44 is coupled by way of an analog-to-digital (A/D) converter 47 to the control logic 48. The telephone interface 45 is to the control logic 48. The control logic 48 implements user-defined access controls for the master appliance 40. The control logic 48 is coupled to a local area network 51, such as an Ethernet network 51, for example. Multiple devices interface to the local area network 51, in a manner similar to devices in the network control center 20.

Devices that are coupled to the local area network 51 include audio and video tuners 52, 53, a wireless RF interface 54 for input devices, a wireless interface 55 for communicating with other wireless devices, such as 802.11, 802.16, 802.64, or Zigby wireless interface 55, a video and voice over Internet protocol (V2OIP™) processor 56, a removable data storage device 57, such as a removable hard drive or USB memory key, a Hilbert database engine 60 including a Hilbert database 60a, a broadband connection 61, such as an Ethernet interface 61, a digital video disk (DVD) and writeable compact disk (CD) drive 62, a video camera 63, a microphone (Mic) 63a, a message board (MB) 64, a universal serial bus (USB) interface 65, a fixed hard disk drive 66, and a Hilbert transform engine 67. The Hilbert transform engine 67 implements an algorithm that, during data transmission, converts a session of digital data into a unique set of numbers, and during reception, converts the unique set of numbers into the session of digital data. Also, while the illustrated master appliance 40 is shown having both the Hilbert database engine 60 and the Hilbert transform engine 67, it is to be understood that the functionality of the two devices may be integrated into a single Hilbert engine. This provides natural data compression and encryption characteristics. Alternatively, conventional compression schemes such as 128 bit or 256 bit compression scemes may be used in place of the Hilbert transform engine 67.

The video tuner 52 provides transmission control to a television (TV) 71. The television 71 may be a non-interactive or an interactive television 71. The audio tuner 53 provides transmission control to an audio (stereo) system 72, which may be made using a wired or wireless connection. The broadband connection 61 connects a voice over Internet protocol phone 75. The voice over Internet protocol phone 75 has a base station that is hard wired by way of an RJ-11 to connect to the telephone company. A wireless telephone may communicate with the base station to make telephone calls. The video and voice over Internet protocol phone 75 may be used to make telephone/video calls using services provided by an Internet protocol (IP) phone company 18, such a Vonage, for example.

The video and voice over Internet protocol (V2OIP) processor 56 is used to interface to a video phone, such as is manufactured by Motorola, for example. In the system 10, the video and voice over Internet protocol (V2OIP) processor 56 in the master appliance 40 comprises a transceiver comparable to the commercially available video telephone. This transceiver is coupled to the camera 63 and microphone 63a, and communicates with the television 71 to display the video telephone conversation on the television 71. The video telephone conversation is displayed in a window on the television 71, in a picture-in-picture format.

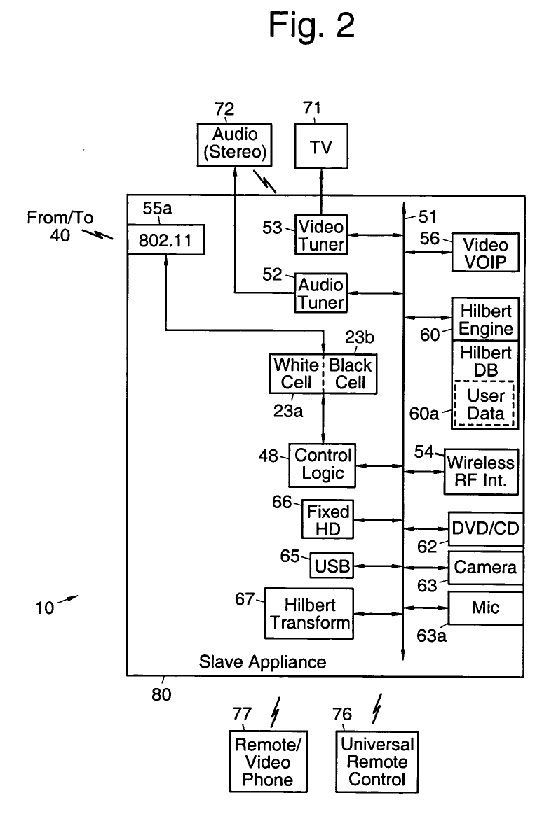

The wireless RF interface 54 communicates with input devices, such as a wireless keyboard 73 and wireless mouse 74. The 802.11 wireless interface 55 may communicate with one or more slave appliances 80, computers, PDA's or other compatible devices. The slave appliance 80 will be discussed in more detail with reference to FIG. 2. However, as is shown in FIG. 1, key components that may be embodied in the slave appliance 80 include a Hilbert database engine comprising a Hilbert database, a Hilbert transform engine, audio and video tuners, a white cell control logic, a wireless interface, a camera and a microphone.

A conventional universal remote control 76 may be used to communicate with the slave appliances 80. A remote control 78 or remote control/video phone 77 may also be used to communicate with the master appliance 40.

The master appliance 40 is operative to store customer lifestyle or profile data including television programming that is watched, the amount of time spent watching television and the channels that are watched, audio and video files that are downloaded, websites 17 that are visited, and products that are purchased. This data is transmitted to the network control center 20 for storage and analysis.

The Hilbert transform engine 67 in the master appliance 40 transforms this data into numerical data (a unique set of integers) for transmission to the network control center 20. At the network control center 20, this data may be stored in its numerical format in the data storage system 24, or the Hilbert transform engine 28 may be used to transform, or morph, the numerical data back to its original form for storage in the data storage system 24. The stored customer-related data may be subsequently processed using the facilities provided by the database interrogation computer 26 and Hilbert database engine 25.

The system 10 integrates communication with substantially all currently available communication and entertainment devices. The system 10 implements high resolution video over Internet protocol communication using a video phone, such as is provided by the remote control/video phone 77. The system 10 provides for downloading of audio and video files wherein the resolution of the downloaded files are the same as original files. This permits downloading of high definition video files.

Key aspects of the system 10 include the use of the Hilbert transform engines 25, 28 and Hilbert transform engines 60, 67 in the network control center 20 and master appliance 40. The Hilbert technology embodied in the Hilbert transform engines 25, 28 and Hilbert transform engines 60, 67 is available from Galaxy Technologies, LLC. This technology will now be described in more detail.

The Hilbert database engine 25 in the master appliance 40 implements an algorithm that is used to convert (morph or transform) data that is stored in the wide storage area network 24 into numbers (integers) that are stored in the Hilbert database 25a. This is illustrated by the dashed arrowed line connecting the wide storage area network 24 and the Hilbert database engine 25.

The Hilbert database engine 25 is a data management and analytical tool including hardware, and operating system and software, that interrogates, reports, analyzes, manipulates and integrates information using a graphical user interface (GUI) that allows users to easily and quickly access, manipulate and analyze data. The Hilbert database engine 25 works by transforming words and numbers (ASCII) stored in the wide storage area network 24 into unique (base-40) integers. These unique (base-40) integers are stored in the Hilbert database 25a in the form of vectors or tensors. The conversion process used in the Hilbert database engine 25 automatically maintains meaning and context so that each stored number has relevance and relationships with other stored numbers.

Once the data from the wide storage area network 24 at the network control center 20 is converted and stored in the Hilbert database 25a of the Hilbert database engine 25, it may be interrogated using the database interrogation computer 26 to query and analyze the data at very high speed. This allows operators to quickly ascertain data stored in the wide storage area network 24, such as data indicative of customer usage of the system 10, thus creating customer addressable Internet protocol specific data usage.

The Hilbert transform engine 28 in the network control center 20 implements an algorithm that is used to transform data transferred between the network control center 20 and the master appliance 40, or transform data for storage in the wide storage area network 24. The Hilbert transform engine 28 implements an algorithm that converts digital data into a unique numbers. More particularly, the Hilbert transform engine 28 is used to transform audio and video files that are either stored locally in the wide storage area network 24. or are retrieved from external sources. for distribution to customers who have ordered them. The transformation process performed by the Hilbert transform engine 25 operates to reduce the size of the audio and video files on the order of 200 times or more and converts them into numerical data containing the complete audio or video files. The transformed audio and video files are transmitted to the customers by way of the Internet 14 and appropriate Internet service provider (cable company 14, telephone company 16).

The Hilbert transform engine 67 in the master appliance 40 is operative to process the downloaded unique numbers corresponding to the audio and video data. The files, when transformed by the Hilbert transform engine 67, produces a full-bandwidth copy of the original audio and video data whose resolution is that of the original files. If the user is authorized to play the downloaded file only once, it is played using the television 71 and/or audio system 72, for example.

Alternatively, if the user is authorized to store and play the downloaded file multiple times, the Hilbert database engine 60 is operative to store the downloaded audio and video files in its numerical format in its Hilbert database 60a. When an audio or video file is to be played, the Hilbert database engine 60 or the Hilbert transform engine 67 converts the stored unique number into a useable data file, which is then played using the television 71 and/or audio system 72, for example.

The Hilbert database engine 60 is used to store user data in the Hilbert database 60a. The user data comprises audio and video files that are ordered via universal resource locators (URLs) of websites 17, items that are ordered over the Internet 15, and companies from whom the items are ordered, television programs and commercials that are watched, telephone numbers that are dialed, authorization data relating to ordered audio and video files, and all related data, audio and video files, and communication.

The Hilbert transform engine 67 is used to transform (Hilbertize) video broadcast data (television programming) that is sent to slave appliances 80. The “Hilbertized” video broadcast data may be transmitted to the slave appliances 80 in the form of packets, or may be streamed as a data session to the slave appliances 80. Thus, different television channels that are received by the master appliance 40 may be “Hilbertized” and communicated to different slave appliances 80 for remote viewing. The Hilbert transform engine in the respective slave appliance 80 is used to reconstruct the television channel for viewing.

The Hilbert transform engine in the slave appliance 80 is also used to transform video and voice over IP (V2OIP) data signals generated by a video telephone, such as the handheld remote/video phone 77, coupled thereto into unique numbers. The transformed integers corresponding to the video and voice over IP data (telephone) signals are wirelessly communicated to the master appliance 40 where the Hilbert transform engine 67 transforms them to convert the unique numbers into video and voice signals for subsequent transmission by way of the IP telephone company 18 to the person to whom the call was made.

One unique aspect of both the master and slave appliances is that they may be used in conjunction with the handheld remote/video phone 77 or a video phone, the camera 63 and microphone 63a, and the television 71 to conduct video and voice communications. For example, if a user is watching television and a video/voice phone call is received, the call is displayed via the television 71 in a picture in picture format. The user may pick up the call by pressing a button on the handheld remote 78. The television 71 displays the person who is calling on the screen and the camera 63 and microphone 63a are used to communicate the video and audio to the caller's video/voice phone.

The master appliance 40 provides for user-control of all functions and services of the system 10 using a television 71 and a remote control 77, 78, which is not available in any currently available product. For example, the master appliance 40 displays electronic mail (email) messages received by the master appliance 40 on the television 71.

Email messages that are received by the master appliance 40 from the Internet 15 are stored in the fixed hard drive 66. Email processing software (including an email program) is implemented as part of the control logic 48 which processes email addressed to family members living at the residence 35, for example. Received email message information is displayed on the television 71, such as in a picture-in-picture window, and which may be selected using a remote control 77, 78 to view contents of the selected message on the television 71. The message may be responded to using the wireless keyboard 73, for example.

The message board (MB) 64 is used to generate local messages that are intended for family members residing at the residence 35. For example, a parent may create a message for a child indicating that the child has a scheduled appointment. When the child turns on the television 71, the control logic 48 is configured to immediately display this message in a picture-in-picture window, for example, thus informing the child that the appointment is scheduled.

In addition, the system 10 provides for interactive video teleconferencing between users of the master appliance 40 over the Internet 15 and also to other slave appliances 80. The camera 63 that is part of each master appliance 40 is used to view participants at the respective location of the master appliance 40. The microphone 63a is used to transmit audio relating to the video teleconferencing between the master appliances 40.

The Hilbert transform engines 67 in master appliances 40 are operative to convert or transform video and audio data generated by the cameras 63 and microphone 63a at a transmitting site into unique numbers substantially in real time. These numbers (which correspond to the video and audio data) is transmitted over the Internet 15 using the IP protocol to master appliances 40 at one or more receiving sites. At the receiving sites, the respective master appliances 40 convert these unique numbers into the originally transmitted video and audio data, substantially in real time. This provides for real time video teleconferencing between master appliances 40 and/or slave appliances 80 at transmitting sites and receiving sites.

During the video teleconferencing, the white cell control logic 23a in each master appliance 40 is also operative to encapsulate data that is transmitted to another master appliance 40. This allows only master appliances 40 that are intended to receive the transmitted data to process it, because the header and trailer records created by the encapsulation defines those that are authorized to receive and process the transmitted data. Furthermore, since the video and audio data is “Hilbertized” by the Hilbert transform engines 67, the transmitted data is unreadable by anyone who intercepts or inadvertently receives the transmitted data.

The removable data storage device 57, such as the removable hard drive or USB memory key, and the fixed hard drive 66 are configured as RAID zero mirroring devices. Consequently, updates made to the removable data storage device 57 are automatically copied to the fixed hard drive 66, and vice-versa. If the removable data storage device 57 is inserted into a vehicle appliance 90, it will synchronize and automatically update the fixed drive 66 in the vehicle 90.

The system 10 may be used to purchase goods and services over the Internet 15. A user connects to a website 17 using a web browser, and which is displayed in the television 71. Goods and services may be selected using one of the remotes 77, 78. The selected remote 77, 78 is used to transact all business via the website 17 using input devices (i.e., keypad and/or mouse) of the remote 77, 78.

Referring to FIG. 2, it shows details of an exemplary slave appliance 80. The slave appliance 80 comprises an 802.11 wireless interface 55a for communicating with the master appliance 40. The 802.11 wireless interface 55a is coupled to white cell and black cell control logic 23a, 23b. The white cell and black cell control logic 23a, 23b are coupled to control logic 48. The control logic 48 is coupled to a local area network 51, such as an Ethernet network 51, for example. Multiple devices interface to the local area network 51, in a manner similar to devices in the master appliance 40.

Devices that are coupled to the local area network 51 include audio and video tuners 52, 53, a wireless RF interface 54, a wireless RF interface 54 for input devices, a video and voice over Internet protocol (V2OIP) processor 56, a Hilbert database engine 60 comprising a Hilbert database 60a, a Hilbert transform engine 67, a digital video disk (DVD) and writable compact disk (CD) drive 62, a video camera 63, a microphone (Mic) 63a, a universal serial bus (USB) interface 65, and a fixed hard disk drive 66. The video tuner 53 is coupled to a television (TV) 71. The conventional universal remote control 76 or the remote control/video phone 77 may be used to communicate with the slave appliance 80.

The functions of the various devices in the slave appliance 80 are substantially identical to those discussed above with regard to the master appliance 40.

The black cell control logic 23b monitors I/O ports of the slave appliance 80 and reads IP addresses of senders of pings to the slave appliance 80. If the sender is not authorized to communicate with the slave appliance 80, the black cell control logic 23b generates an alarm signal, sends the alarm signal to the network control center 20, and does not return the ping.

The 802.11 wireless interface 55a is used to communicate with the master appliance 40. Video and audio data corresponding to a television channel that a user of the slave appliance 80 would like to watch are “Hilbertized” at the master appliance 40 and transmitted by way of the 802.11 wireless interface 55a to the slave appliance 80. The Hilbert transform engine 67 in the slave appliance 80 recovers the video and audio data corresponding to the television channel. The control logic 48 is operative to transfer the video and audio data to the audio and video tuners 52, 53 which present the television channel on the television 71 coupled to the slave appliance 80.

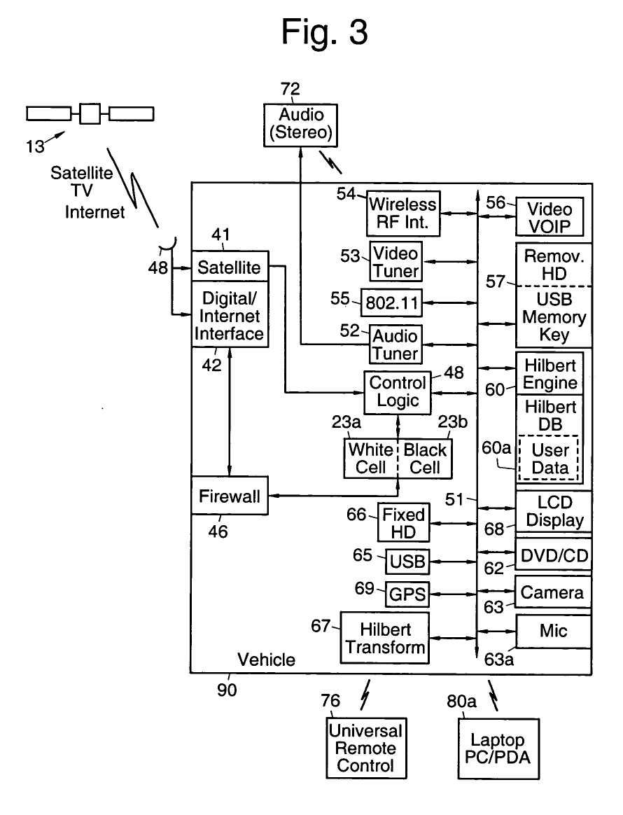

FIG. 3 illustrates details of an exemplary vehicle appliance 40a. The vehicle appliance 40a comprises a satellite receiver 41 coupled to an antenna 48 for receiving television broadcasts from satellites 13. A digital/Internet interface 42 is provided for receiving digital and Internet traffic routed over the Internet 15 by way of the user's Internet service provider.

The digital/Internet interface 42 is coupled to a firewall 46. The firewall 46 is coupled to white cell and black cell control logic 23a, 23b. The firewall 46 along with the white cell and black cell control logic 23a, 23b cooperate to secure the master appliance 40 in the same manner as was described with regard to the network control center 20.

The white cell and black cell control logic 23a, 23b along with the satellite receiver 41 are coupled to control logic 48. The control logic 48 implements user-defined access controls for the vehicle appliance 40a. The control logic 48 is coupled to a local area network 51, such as an Ethernet network 51, for example. Multiple devices interface to the local area network 51 in a manner similar to devices in the master appliance 40, for example.

Devices that are coupled to the local area network 51 include audio and video tuners 52, 53, an 802.11 wireless interface 55, a video and voice over Internet protocol (V2OIP) processor 56, a removable data storage device 57, such as a removable hard drive or USB memory key, for example, a Hilbert database engine 60 including a Hilbert database 60a, a digital video disk (DVD) and compact disk (CD) drive 62, a video camera 63, a microphone (Mic) 63a, a universal serial bus (USB) interface 65, a fixed hard disk drive 66, a Hilbert transform engine 67, a liquid crystal display (LCD) 68, and a Global Positioning System, (GPS) processor 69. These devices are configured in the manner discussed with regard to the master appliance 40.

A conventional universal remote control 76 may be used to communicate with the vehicle appliance 40a. Alternatively, a remote control 78 or remote control/video phone 77 such as was described with reference to FIG. 1 may be used to communicate with the vehicle appliance 40a. Also, a computer device 80a, such as a laptop personal computer or PDA, for exmaple, may also communicate with the vehicle appliance 40a.

The vehicle appliance 40a is installed in a dashboard of a vehicle so that the liquid crystal display (LCD) 68 is pivotable or rotate able to position it so that a driver cannot see it when the vehicle is in motion. When the vehicle transmission is not in park, the liquid crystal display 68 is rotated to the right, toward the passenger door. When the vehicle transmission is in park, the liquid crystal display 68 is rotated so that it is viewable by the driver.

The vehicle appliance 40a is configured to have a removable data storage device 57. In operation, the removable data storage device 57 from the master appliance 40 is removed there from and inserted into the vehicle appliance 40a. Thus, audio and video files that were downloaded to the master appliance 40 may be viewed by way of the vehicle appliance 40a.

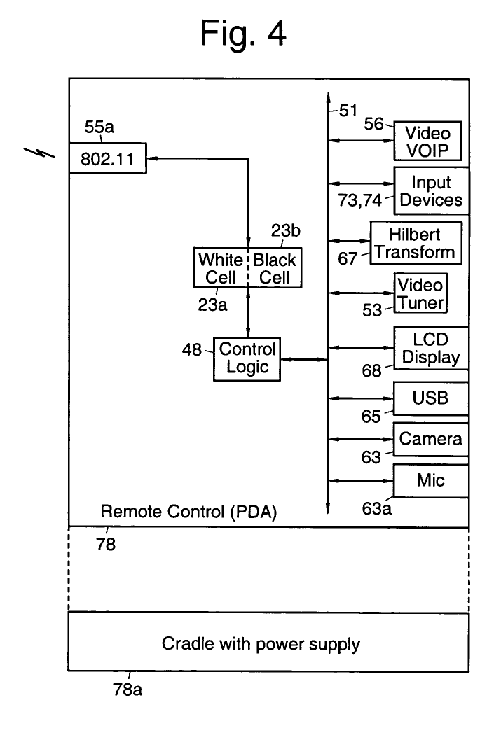

FIG. 4 illustrates details of an exemplary video and voice remote control 78, comprising a personal digital assistant (PDA) 78. The video and voice remote control 78 or PDA 78 comprises an wireless interface 55a for communicating with the master appliance 40. The wireless interface 55a is coupled to white cell and black cell control logic 23a, 23b. The white cell and black cell control logic 23a, 23b are coupled by way of control logic 48 to a local area network 51. Multiple devices interface to the local area network 51, in a manner similar to devices in the master appliance 40. The exemplary video and voice remote control 78, or personal digital assistant 78, may be used in conjunction with a cradle 78a having a power supply, to supply power, in lieu of batteries.

Devices that are coupled to the local area network 51 include a video and voice over Internet protocol (V2OIP) processor 56, input devices 73, 74 (i.e., key pad and/or mouse), a Hilbert transform engine 67, a video camera 63, a microphone (Mic) 63a, a universal serial bus (USB) interface 65, and a liquid crystal display (LCD) 68. This device may be used as a remote control for the television 71, as a video phone, as a control device for Internet access, and as a monitoring tool for slave and vehicle appliances 80, 90.

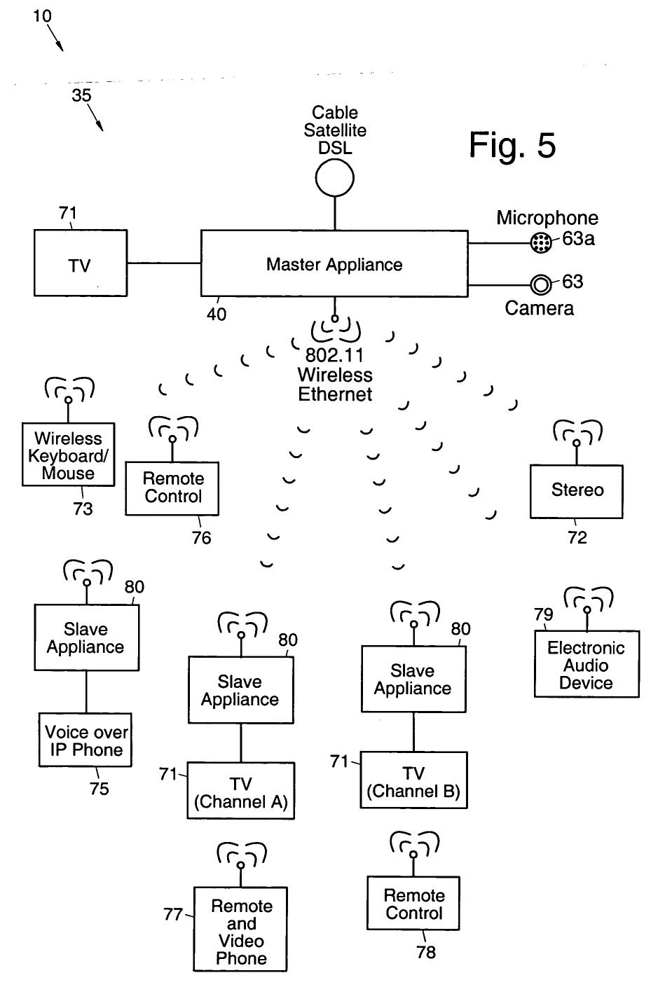

FIG. 5 is a functional block diagram of the system 10. Signals are received by the master appliance 40 from cable, satellite and DSL sources. The master appliance 40 distributes received television signals to the television (TV) 71 under control of a wireless remote control 76, for example. The wireless input device 73, 74 (keyboard 52 and mouse 74) communicates with the master appliance 40 to control functions of the wireless remote control 76. The wireless input device 73, 74 interacts with the master appliance 40 to send and receive email messages, order items over the Internet 15 from websites 17, and download audio and video files, for example. The camera 63 permits interactive communication with others using a video over IP phone 77, for example. This permits videoconferencing and interactive user-to-user telephone conversations.

FIG. 5 shows two slave appliances 80 that wirelessly communicate with the master appliance 40. The use of the Hilbert transform engines 67 in the master and slave appliances 40, 80 allows multiple television channels to be transformed into numerical data to allow their transfer from the master appliance 40 to the slave appliances 80. This allows individual slave appliance 80 to view separate television channels. FIG. 5 also shows that audio files may be wirelessly transmitted to a digital audio device 72, such as stereo system 72 or a digital electronic device 79, such as an IPOD® for example.

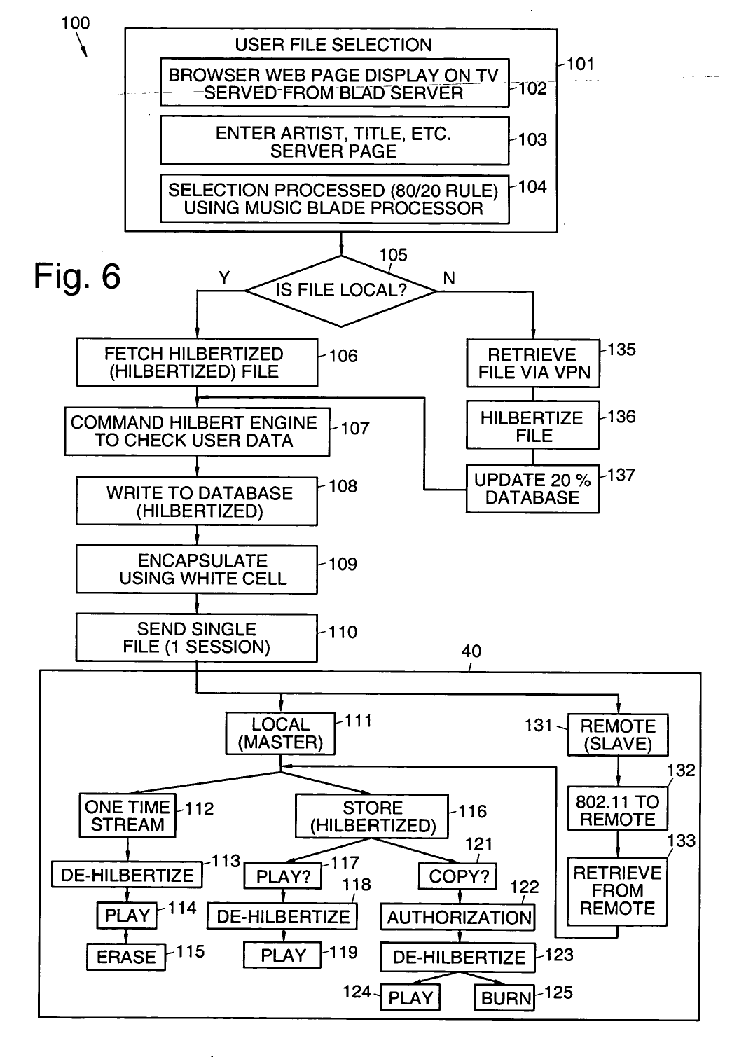

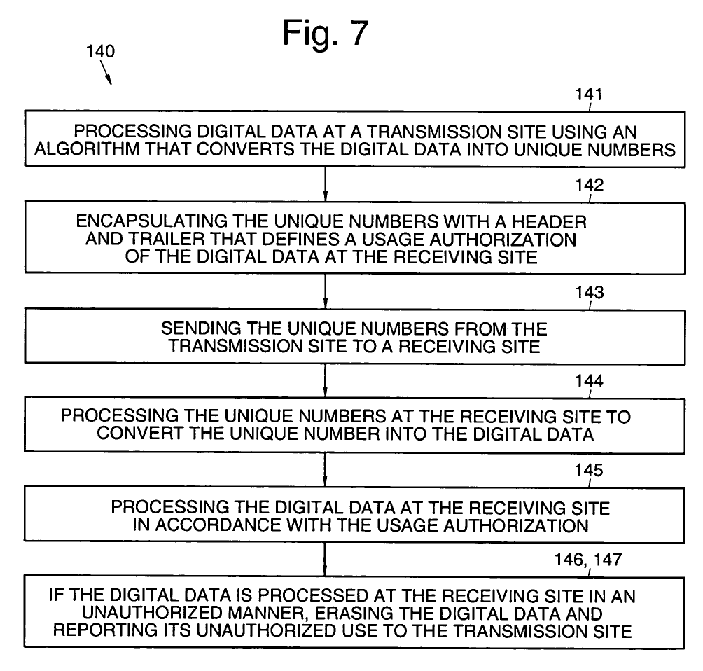

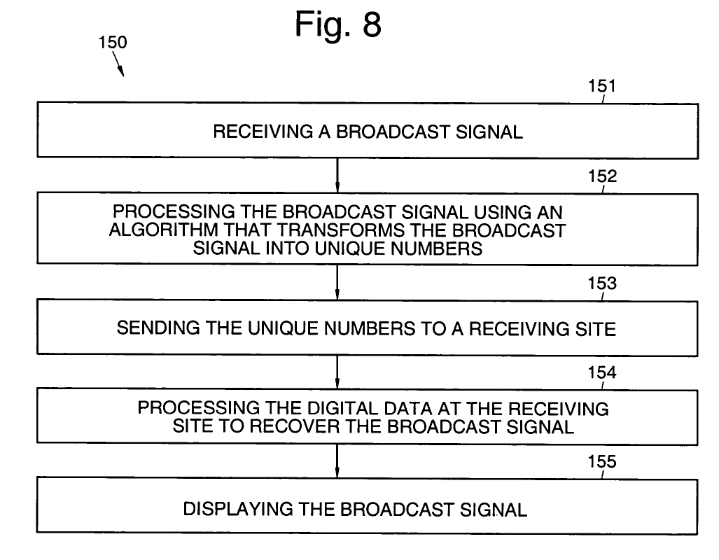

FIG. 6 is an exemplary process flow diagram illustrating an exemplary file download to a master appliance 40. The process starts with user file selection 101. A user displays 102 a browser web page. The user enters 103 data into the browser web page defining the selection. The selection is them processed 104 under a 80/20 rule using a music blade processor 24. Under the 80/20 rule, 20 percent of the audio and video files (i.e., the most frequently ordered) are stored in the wide storage area network 24 in a numerical (Hilbertized) format, and the remaining 80 percent (i.e., those that are not frequently ordered) are retrieved from a virtual music or video source.

A determination 105 is made if the file is locally stored. If the file is locally stored in the wide storage area network 24, the transformed (Hilbertized) file is fetched 106, or retrieved 106, from the wide storage area network 24. The blade server 17 commands the Hilbert engine 25 to check 107 for user data. The transaction data is written 108 to the customer's file in the wide storage area network 24. The retrieved transformed (Hilbertized) file is encapsulated 109 using the white cell control logic 23a. The file is transmitted 110 as a single file in one session.

If the file is destined for the master appliance 40 (i.e., local 111), if the authorization 112 of user is to play the file only one time, the file is recovered 113 (i.e., “De-Hilbertized” or converted from integer representation into readable data) and played 114 and then erased 115. If the authorization 112 of user is to play the file multiple times, the file is stored 116 in a numerical (Hilbertized) format. Then, if the user desires to play 117 the file, it is recovered 118 (i.e., “De-Hilbertized” or converted from the integer representation into readable data) and played 119. If the user is to copy 121 the file, the user's authorization is determined 122 (as to if the file can be copies or played), and the file is recovered 123 (“De-Hilbertized”). The user can then play 124, or burn 125 a copy of the recovered file.

If a determination 105 is made that the file is not locally stored, it is retrieved 135 from a via a virtual private network (VPN), for example, from a source. The file is “Hilbertized” 136 (i.e., converted to a numerical format). The 20% database is updated 137 to reflect that this file is one of the most recently processed.

An advantageous aspect of the system 10 is that customer lifestyle or profile data, such as television programming that is watched, the amount of time spent watching television and the channels that are watched, audio and video files that are downloaded, websites 17 that are visited, and products that are purchased from websites 17, for example, are transmitted from master appliances 40 and stored at the network control center 20 in the wide storage area network 24. The database interrogation computer 26 in conjunction with the Hilbert database engine 25 and Hilbert database 25a, are used to retrieve the stored data and analyze the data for analytical and predictive purposes. This data provides for 99.999 percent accurate customer information, which provides much more than Nielson ratings information. This data also provides 99.999 percent accurate information for advertising.

A basic aspect of the system 10 is that it provides for distribution of data, such as audio and video data, over the Internet 15 using an Internet protocol and Hilbert transformation. The Hilbert transformation scheme employed in the system 10 permits substantially real-time transmission of video, voice and other data between devices over the Internet 15.

FIG. 7 is a flow chart that illustrates exemplary methods 140 that may be implemented using the concepts discussed above. The exemplary methods 140 are implemented as follows.

Digital data is processed 141 at a transmission site using an algorithm that converts the digital data into a unique set of numbers. The unique set of numbers may be encapsulated 142 with a header and trailer that defines a usage authorization of the digital data at a receiving site. The unique (encapsulated) numbers are sent 143 from the transmission site to a receiving site, which may be a wireless transmission or a transmission over the Internet 15 using an Internet protocol. The unique numbers are processed 144 at the receiving site to recover the digital data, i.e., convert the unique numbers into the digital data. The digital data may be processed 145 at the receiving site in accordance with the usage authorization. If the digital data is processed at the receiving site in an unauthorized manner, the digital data is erased 146 and its unauthorized use is reported 147 to the transmission site.

FIG. 8 is a flow chart that illustrates other exemplary methods 150 that may be implemented using the concepts discussed above. The exemplary methods 150 are implemented as follows. A broadcast signal is received 151 at a first site. The broadcast signal is processed 152 using at the first site an algorithm that transforms the broadcast signal into a unique number. The broadcast signal may be a digital signal that is transformed into unique numbers, or an analog signal that is converted into a digital signal that is then transformed into unique numbers. The unique numbers are sent 153 to a second site. The unique numbers are processed 154 at the second site to recover the broadcast signal. The broadcast signal is displayed at the second site, such as by way of a television 71.

Thus, a multimedia distribution and analysis system employing integrated entertainment appliances, and related processing methods, have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A method comprising:
processing digital data at a transmission site using an algorithm that transforms the digital data into a set of unique numbers;
transmitting the unique numbers from the transmission site to a receiving site; and
processing the unique numbers at the receiving site to recover the digital data from the unique numbers.

2. The method recited in claim 1 wherein the unique numbers are transmitted from the transmission site to a receiving site over the Internet using an Internet protocol.

3. The method recited in claim 1 further comprising:
displaying the recovered digital data on a television at the receiving site.

4. The method recited in claim 1 further comprising:
storing the unique numbers corresponding to the digital data at the receiving site.

5. The method recited in claim 1 further comprising:
encapsulating the unique number with a header and trailer that defines a usage authorization of the digital data at the receiving site.

6. The method recited in claim 5 further comprising:
processing the digital data at the receiving site in accordance with the usage authorization.

7. The method recited in claim 6 further comprising:
if the digital data is processed at the receiving site in an unauthorized manner, erasing the digital data and reporting its unauthorized use to the transmission site.

8. The method recited in claim 1 wherein the digital data comprises audio, video, voice, or video and voice data.

9. The method recited in claim 1 further comprising:
storing data relating to multiple transmissions of digital data in a data storage system;
processing the data relating to the multiple transmissions using an algorithm that converts the data relating to the multiple transmissions into unique numbers;
storing the unique numbers in a numeric database; and
processing the unique numbers from the numeric database to query and analyze the unique numbers to ascertain information regarding the transmissions.

10. Apparatus comprising:
a television tuner for connection to a television;
control logic that is in communication with the television tuner, and that processes digital data for display on the television by way of the television tuner; and
a first processor including a database, for processing data relating to the digital data using an algorithm that transforms the data relating to the digital data into unique numbers and for storing the unique numbers in the database.

11. The apparatus recited in claim 10 further comprising:
a firewall system coupled to the control logic for preventing unauthorized access to the apparatus; and
one or more interfaces coupled between the Internet and the firewall system for receiving the digital data over the Internet and for transferring the digital data by way of the firewall system to the control logic.

12. The apparatus recited in claim 10 wherein the digital data is in the form of a unique number and wherein the apparatus further comprises a second processor that is in communication with the control logic and television tuner for processing the unique number to recover the digital data for display on the television by way of the television tuner.

13. The apparatus recited in claim 12 wherein the unique number corresponding to the digital data is stored in the database.

14. The apparatus recited in claim 12 wherein the unique number is encapsulated with a header and trailer that defines a usage authorization of the digital data, and wherein the control logic processes the digital data in accordance with the usage authorization.

15. The apparatus recited in claim 10 wherein the control logic erases the digital data and reports its unauthorized use to the database if the digital data is processed in an unauthorized manner.

16. The apparatus recited in claim 10 wherein the digital data comprises an electronic mail message and wherein the electronic mail message is processed for display on the television.

17. The apparatus recited in claim 10 further comprising:
a second processor that is in communication with the control logic for processing the digital data to convert it into a second set of unique numbers; and
slave apparatus in wireless communication with the apparatus, for wirelessly receiving the second set of unique numbers, for converting the second set of unique numbers into the digital data, and for processing the digital data for display on a television coupled to the slave apparatus.

18. The apparatus recited in claim 17 wherein the slave apparatus comprises control logic for erasing the digital data and reporting its unauthorized use to the database if the digital data is processed at the slave apparatus in an unauthorized manner.

19. The apparatus recited in claim 10 further comprising:
a network control center, in communication with the apparatus, for storing unique numbers corresponding to digital data processed for display by the apparatus, and for processing the unique numbers to query and analyze the unique numbers to ascertain information regarding usage of the apparatus.

20. The apparatus recited in claim 10 further comprising:
a remote control/video phone; and
a video over Internet protocol processor in communication with the remote control/video phone and the control logic for processing signals received from the remote control/video phone and for communicating them over the Internet.

21. The apparatus recited in claim 10 further comprising:
control logic for erasing the digital data and reporting its unauthorized use to the database if the digital data is processed in an unauthorized manner.

22. A method comprising:
receiving a broadcast signal;
processing the broadcast signal using an algorithm that transforms it into unique numbers;
sending the unique numbers to a receiving site;
processing the unique numbers at the receiving site to recover the broadcast signal; and
displaying the broadcast signal.

23. The method recited in claim 22 wherein the received broadcast signal is a digital signal that is transformed into the unique number.

24. The method recited in claim 22 wherein the received broadcast signal is an analog signal, and wherein the analog signal is converted into a digital signal that is transformed into the unique numbers.
